(19) United States
(12) Patent Application Publication
(10) Pub. No.: US 2016/0277091 A1
(43) Pub. Date: Sep. 22, 2016

(54) METHOD AND APPARATUS FOR TRANSMITTING FEEDBACK OF SINGLE FEEDBACK CHAIN-BASED CHANNEL STATUS INFORMATION FOR 3D MIMO IN A WIRELESS COMMUNICATION SYSTEM

(71) Applicant: LG ELECTRONICS INC., Seoul (KR)

(72) Inventors: Hyungtae KIM, Seoul (KR); Kijun KIM, Seoul (KR); Jonghyun PARK, Seoul (KR)

(73) Assignee: LG ELECTRONICS INC., Seoul (KR)

(21) Appl. No.: 15/013,617

(22) Filed: Feb. 2, 2016

Related U.S. Application Data
(60) Provisional application No. 62/136,622, filed on Mar. 22, 2015.

(51) Int. Cl. H04B 7/06; H04W 72/04

(52) U.S. Cl. CPC H04B 7/0626; H04W 72/0446

(57) ABSTRACT

A method for reporting Channel Status Information (CSI) to a Base Station (BS) by a User Equipment (UE) in a wireless communication system is disclosed. The method includes receiving information about a CSI process configured with multiple reference signals from the BS, reporting an indicator indicating at least one reference signal for the CSI among the multiple reference signals to the BS, generating the CSI based on the at least one reference signal, and reporting the generated CSI to the BS. Here, a report type of the CSI is determined based on the indicator indicating the at least one reference signal.

This application claims the benefit of U.S. Provisional Application No. 62/136,622, filed on Mar. 22, 2015, which is hereby incorporated by reference as if fully set forth herein.

### BACKGROUND OF THE INVENTION

1. Field of the Invention

The present invention relates to a wireless communication system, and more particularly, to a method and apparatus for transmitting a feedback of single feedback chain-based channel status information for Three-Dimensional (3D) Multiple Input Multiple Output (MIMO) in a wireless communication system.

2. Discussion of the Related Art

As an example of a wireless communication system to which the present invention is applicable, a 3rd Generation Partnership Project Long Term Evolution (3GPP LTE) (hereinafter, referred to as ‘LTE’) communication system is briefly described.

FIG. 1 is a view schematically illustrating the network architecture of an E-UMTS as an exemplary wireless communication system. An Evolved Universal Mobile Telecommunications System (E-UMTS) is an advanced version of a legacy Universal Mobile Telecommunications System (UMTS) and standardization thereof is currently underway in the 3GPP. E-UMTS may be generally referred to as an LTE system. For details of the technical specifications of UMTS and E-UMTS, reference can respectively be made to Release 7 and Release 8 of “3rd Generation Partnership Project; Technical Specification Group Radio Access Network”.

Referring to FIG. 1, the E-UMTS includes a User Equipment (UE), eNode Bs (eNBs), and an Access Gateway (AG) which is located at an end of a network (Evolved-Universal Terrestrial Radio Access Network ((E-UTRAN)) and connected to an external network. The eNBs may simultaneously transmit multiple data streams for a broadcast service, a multicast service, and/or a unicast service.

One or more cells may exist in one eNB. A cell is configured to use one of bandwidths of 1.25, 2.5, 5, 10, 20 MHz to provide a downlink or uplink transport service to several UEs. Different cells may be configured to provide different bandwidths. The eNB controls data transmission and reception for a plurality of UEs. The eNB transmits downlink scheduling information for downlink data to notify a corresponding UE of a data transmission time/frequency domain, coding, data size, and Hybrid Automatic Repeat and reQuest (HARQ)-related information. In addition, the eNB transmits uplink scheduling information for uplink data to inform a corresponding UE of available time/frequency domains, coding, data size, and HARQ-related information. An interface for transmitting user traffic or control traffic may be used between eNBs. A Core Network (CN) may include an AG and a network node for user registration of the UE. The AG manages mobility of the UE on a Tracking Area (TA) basis, wherein one TA consists of a plurality of cells.

Although radio communication technology has been developed up to LTE based on Wideband Code Division Multiple Access (WCDMA), demands and expectations of users and service providers have continued to increase. In addition, since other radio access technologies continue to be developed, new technical evolution is required for future competitiveness. Decrease of cost per bit, increase of service availability, flexible use of a frequency band, simple structure and open interface, and suitable power consumption by a UE are required.

### SUMMARY OF THE INVENTION

Accordingly, the present invention is directed to a method and apparatus for transmitting a feedback of single feedback chain-based channel status information for Three-Dimensional (3D) Multiple Input Multiple Output (MIMO) in a wireless communication system that substantially obviate one or more problems due to limitations and disadvantages of the related art.

An object of the present invention is to provide a method and apparatus for transmitting a feedback of single feedback chain-based channel status information for 3D MIMO in a wireless communication system.

It will be appreciated by persons skilled in the art that that the technical objects that can be achieved through the present invention are not limited to what has been particularly described hereinabove and other technical objects of the present invention will be more clearly understood from the following detailed description.

To achieve these objects and other advantages and in accordance with the purpose of the invention, as embodied and broadly described herein, a method for reporting Channel Status Information (CSI) to a Base Station (BS) by a User Equipment (UE) in a wireless communication system. The method includes receiving information about a CSI process configured with multiple reference signals from the BS, reporting an indicator indicating at least one reference signal for the CSI among the multiple reference signals to the BS, generating the CSI based on the at least one reference signal, and reporting the generated CSI to the BS. Here, a report type of the CSI is determined based on the indicator indicating the at least one reference signal.

In another aspect of the present invention, a method for receiving Channel Status Information (CSI) from by a User Equipment (UE) by a Base Station (BS) in a wireless communication system is disclosed. The method includes transmitting information about a CSI process configured with multiple reference signals to the UE, receiving an indicator indicating at least one reference signal for the CSI among the multiple reference signals from the UE, and receiving the CSI generated based on the at least one reference signal from the UE.

If both of the first CSI and the second CSI are generated, the first CSI and the second CSI may be reported individually in different subframes indicated by the one CSI process. Or the first CSI and the second CSI may be reported simultaneously in a subframe indicated by the one CSI process. Here, a report type of the CSI is determined based on the indicator indicating the at least one reference signal.

Preferably, the report type of the CSI comprises at least one of a payload size of the CSI, a number of precoder indicators and a size of each of the precoder indicators.

More preferably, if a number of the at least one reference signal is 1, the size of the precoder indicator increases in correspondence with the payload size of the CSI. On the other hand, if the number of the at least one reference signal is plural, CSIs generated using different reference signals are reported in different subframes indicated by the CSI process.

Preferably, the indicator indicating at least one reference signal comprises a rank indicator.

Further, vertical beamforming may be applied at different angles to the first reference signal and the second reference signal.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 schematically illustrates the network architecture of an E-UMTS as an exemplary wireless communication system;

FIG. 2 illustrates structures of a control plane and a user plane of a radio interface protocol between a UE and an E-UTRAN based on the 3GPP radio access network specification;

FIG. 3 illustrates physical channels used in a 3GPP system and a general signal transmission method using the same;

FIG. 4 illustrates the structure of a radio frame used in an LTE system;

FIG. 5 illustrates the structure of a downlink radio frame used in an LTE system;

FIG. 6 illustrates the structure of an uplink subframe used in the LTE system;

FIG. 7 illustrates the configuration of a general MIMO communication system;

FIG. 8 illustrates an example of performing CoMP;

FIG. 9 illustrates a downlink CoMP operation;

FIG. 10 illustrates an example of implementation of the 2D-AAS;

FIG. 11 is an example of implementation of the cross-polarized antenna array having 64 antenna elements;

FIG. 12 illustrates an example of Channel status information (CSI) feedback through one Physical Uplink Control Channel (PUCCH) feedback chain according to an embodiment of the present invention;

FIG. 13 illustrates another example of CSI feedback through one PUCCH feedback chain according to an embodiment of the present invention;

FIG. 14 illustrates another example of CSI feedback through one PUCCH feedback chain according to an embodiment of the present invention; and

FIG. 15 is a diagram showing a BS and a UE which are applicable to the present invention.

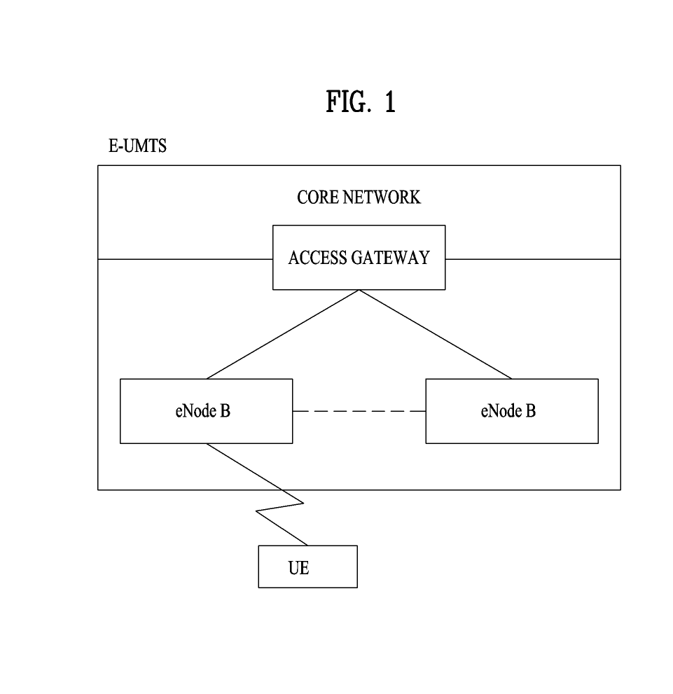

### DETAILED DESCRIPTION OF THE INVENTION

Hereinafter, the structures, operations, and other features of the present invention will be understood readily from the embodiments of the present invention, examples of which are described with reference to the accompanying drawings. The embodiments which will be described below are examples in which the technical features of the present invention are applied to a 3GPP system.

Although the embodiments of the present invention will be described based on an LTE system and an LTE-Advanced (LTE-A) system, the LTE system and the LTE-A system are only exemplary and the embodiments of the present invention can be applied to all communication systems corresponding to the aforementioned definition. In addition, although the embodiments of the present invention will herein be described based on Frequency Division Duplex (FDD) mode, the FDD mode is only exemplary and the embodiments of the present invention can easily be modified and applied to Half-FDD (H-FDD) mode or Time Division Duplex (TDD) mode.

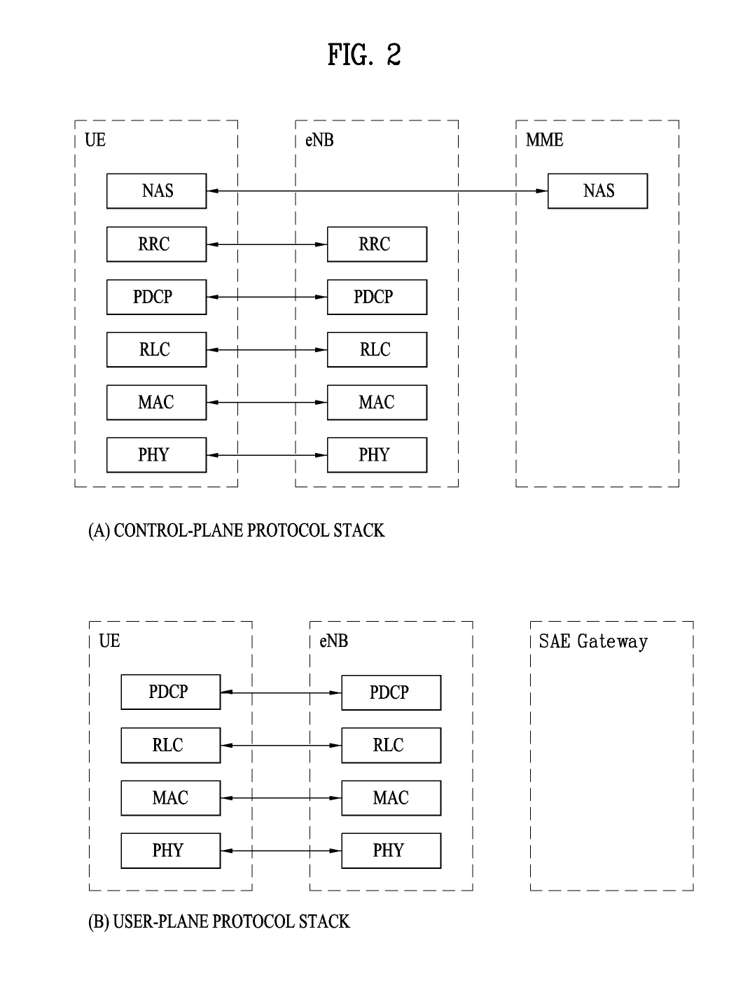

FIG. 2 is a view illustrating structures of a control plane and a user plane of a radio interface protocol between a UE and an E-UTRAN based on the 3GPP radio access network specification. The control plane refers to a path through which control messages used by a User Equipment (UE) and a network to manage a call are transmitted. The user plane refers to a path through which data generated in an application layer, e.g. voice data or Internet packet data, is transmitted.

A physical layer of a first layer provides an information transfer service to an upper layer using a physical channel. The physical layer is connected to a Medium Access Control (MAC) layer of an upper layer via a transport channel. Data is transported between the MAC layer and the physical layer via the transport channel. Data is also transported between a physical layer of a transmitting side and a physical layer of a receiving side via a physical channel. The physical channel uses time and frequency as radio resources. Specifically, the physical channel is modulated using an Orthogonal Frequency Division Multiple Access (OFDMA) scheme in downlink and is modulated using a Single-Carrier Frequency Division Multiple Access (SC-FDMA) scheme in uplink.

A MAC layer of a second layer provides a service to a Radio Link Control (RLC) layer of an upper layer via a logical channel. The RLC layer of the second layer supports reliable data transmission. The function of the RLC layer may be implemented by a functional block within the MAC. A Packet Data Convergence Protocol (PDCP) layer of the second layer performs a header compression function to reduce unnecessary control information for efficient transmission of an Internet Protocol (IP) packet such as an IPv4 or IPv6 packet in a radio interface having a relatively narrow bandwidth.

A Radio Resource Control (RRC) layer located at the bottommost portion of a third layer is defined only in the control plane. The RRC layer controls logical channels, transport channels, and physical channels in relation to configuration, re-configuration, and release of radio bearers. The radio bearers refer to a service provided by the second layer to transmit data between the UE and the network. To this end, the RRC layer of the UE and the RRC layer of the network exchange RRC messages. The UE is in an RRC connected mode if an RRC connection has been established between the RRC layer of the radio network and the RRC layer of the UE. Otherwise, the UE is in an RRC idle mode. A Non-Access Stratum (NAS) layer located at an upper level of the RRC layer performs functions such as session management and mobility management.

One cell of an eNB is set to use one of bandwidths such as 1.25, 2.5, 5, 10, 15, and 20 MHz to provide a downlink or uplink transmission service to a plurality of UEs. Different cells may be set to provide different bandwidths.

Downlink transport channels for data transmission from a network to a UE include a Broadcast Channel (BCH) for transmitting system information, a Paging Channel (PCH) for transmitting paging messages, and a downlink Shared Channel (SCH) for transmitting user traffic or control messages. Traffic or control messages of a downlink multicast or broadcast service may be transmitted through the downlink SCH or may be transmitted through an additional downlink Multicast Channel (MCH). Meanwhile, uplink transport channels for data transmission from the UE to the network include a Random Access Channel (RACH) for transmitting initial control messages and an uplink SCH for transmitting user traffic or control messages. Logical channels, which are located at an upper level of the transport channels and are mapped to the transport channels, include a Broadcast Control Channel (BCCH), a Paging Control Channel (PCCH), a Common Control Channel (CCCH), a Multicast Control Channel (MCCH), and a Multicast Traffic Channel (MTCH).

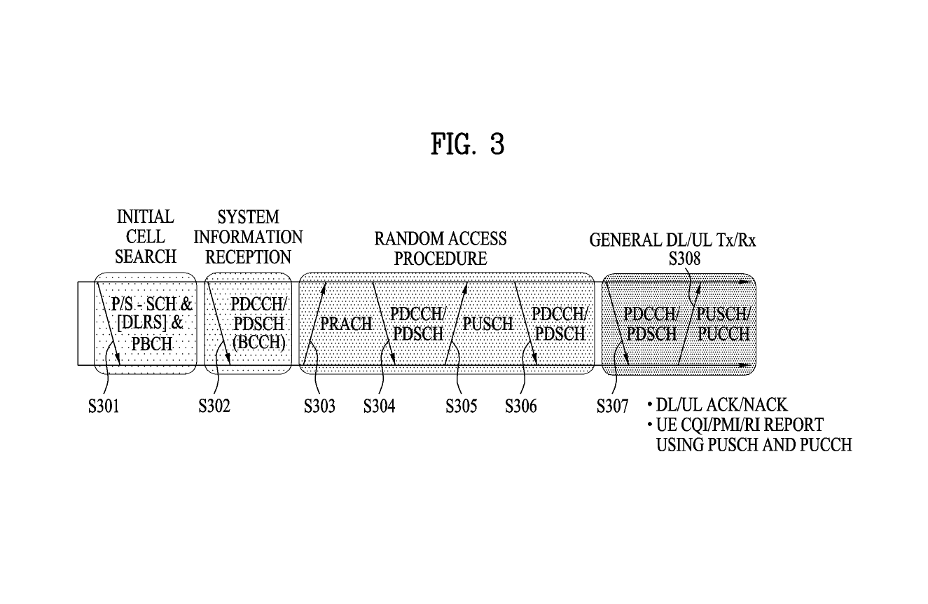

FIG. 3 is a view illustrating physical channels used in a 3GPP system and a general signal transmission method using the same.

A UE performs initial cell search such as establishment of synchronization with an eNB when power is turned on or the UE enters a new cell (step S301). The UE may receive a Primary Synchronization Channel (P-SCH) and a Secondary Synchronization Channel (S-SCH) from the eNB, establish synchronization with the eNB, and acquire information such as a cell identity (ID). Thereafter, the UE may receive a physical broadcast channel from the eNB to acquire broadcast information within the cell. Meanwhile, the UE may receive a Downlink Reference Signal (DL RS) in the initial cell search step to confirm a downlink channel state.

Upon completion of initial cell search, the UE may receive a Physical Downlink Control Channel (PDCCH) and a Physical Downlink Shared Channel (PDSCH) according to information carried on the PDCCH to acquire more detailed system information (step S302).

Meanwhile, if the UE initially accesses the eNB or if radio resources for signal transmission are not present, the UE may perform a random access procedure (steps S303 to S306) with respect to the eNB. To this end, the UE may transmit a specific sequence through a Physical Random Access Channel (PRACH) as a preamble (steps S303 and S305), and receive a response message to the preamble through the PDCCH and the PDSCH corresponding thereto (steps S304 and S306). In the case of a contention-based RACH, a contention resolution procedure may be additionally performed.

The UE which performs the above procedures may receive a PDCCH/PDSCH (step S307) and transmit a Physical Uplink Shared Channel (PUSCH)/Physical Uplink Control Channel (PUCCH) (step S308) according to a general uplink/downlink signal transmission procedure. Especially, the UE receives Downlink Control Information (DCI) through the PDCCH. The DCI includes control information such as resource allocation information for the UE and has different formats according to use purpose.

Meanwhile, control information, transmitted by the UE to the eNB through uplink or received by the UE from the eNB through downlink, includes a downlink/uplink ACKnowledgment/Negative ACKnowledgment (ACK/NACK) signal, a Channel Quality Indicator (CQI), a Precoding Matrix Index (PMI), a Rank Indicator (RI), and the like. In the case of the 3GPP LTE system, the UE may transmit control information such as CQI/PMI/RI through the PUSCH and/or the PUCCH.

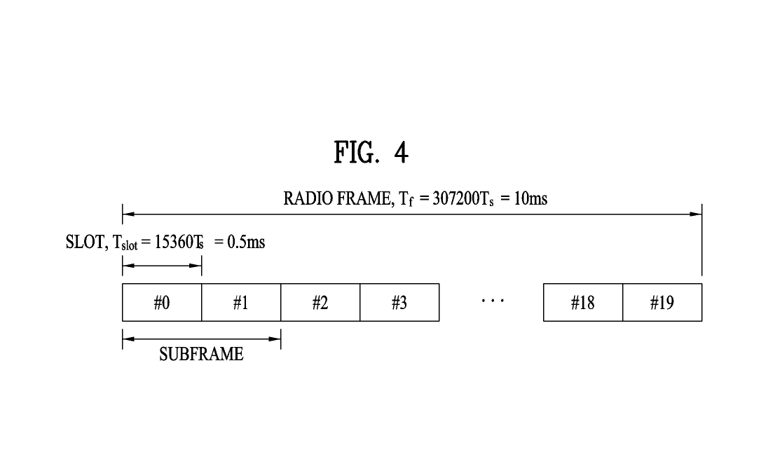

FIG. 4 is a view illustrating the structure of a radio frame used in an LTE system.

Referring to FIG. 4, the radio frame has a length of 10 ms (327200 Tₛ) and includes 10 equally-sized subframes. Each of the subframes has a length of 1 ms and includes two slots. Each of the slots has a length of 0.5 ms (15360 Tₛ). In this case, Tₛ denotes sampling time and is represented by Tₛ=1/(15 kHz×2048)=3.2552×10⁻⁸ (about 33 ns). Each slot includes a plurality of OFDM symbols in a time domain and includes a plurality of Resource Blocks (RBs) in a frequency domain. In the LTE system, one resource block includes 12 subcarriers×7 (or 6) OFDM symbols. A Transmission Time Interval (TTI), which is a unit time for data transmission, may be determined in units of one or more subframes. The above-described structure of the radio frame is purely exemplary and various modifications may be made in the number of subframes included in a radio frame, the number of slots included in a subframe, or the number of OFDM symbols included in a slot.

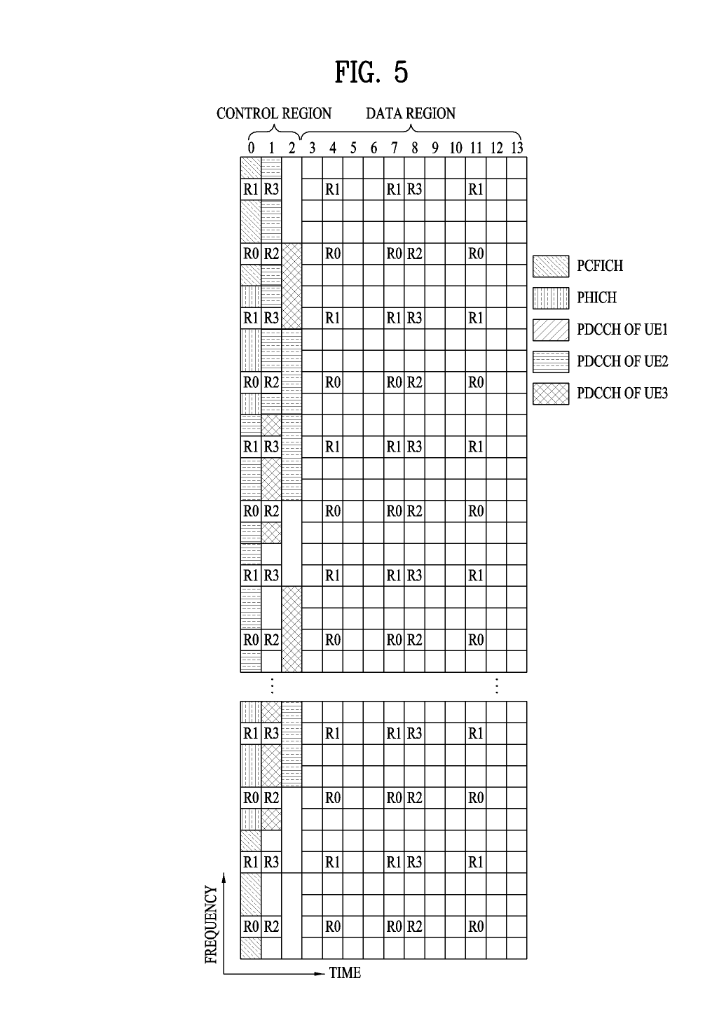

FIG. 5 is a view illustrating control channels contained in a control region of one subframe in a downlink radio frame.

Referring to FIG. 5, one subframe includes 14 OFDM symbols. The first to third ones of the 14 OFDM symbols may be used as a control region and the remaining 13 to 11 OFDM symbols may be used as a data region, according to subframe configuration. In FIG. 5, R1 to R4 represent reference signals (RSs) or pilot signals for antennas 0 to 3, respectively. The RSs are fixed to a predetermined pattern within the subframe irrespective of the control region and the data region. Control channels are allocated to resources to which the RS is not allocated in the control region. Traffic channels are allocated to resources, to which the RS is not allocated, in the data region. The control channels allocated to the control region include a Physical Control Format Indicator Channel (PCFICH), a Physical Hybrid-ARQ Indicator Channel (PHICH), a Physical Downlink Control Channel (PDCCH), etc.

The PCFICH, physical control format indicator channel, informs a UE of the number of OFDM symbols used for the PDCCH per subframe. The PCFICH is located in the first OFDM symbol and is established prior to the PHICH and the PDCCH. The PCFICH is comprised of 4 Resource Element Groups (REGs) and each of the REGs is distributed in the control region based on a cell ID. One REG includes 4 Resource Elements (REs). The RE indicates a minimum physical resource defined as one subcarrier×one OFDM symbol. The PCFICH value indicates values of 1 to 3 or values of 2 to 4 depending on bandwidth and is modulated by Quadrature Phase Shift Keying (QPSK).

The PHICH, physical Hybrid-ARQ indicator channel, is used to transmit a HARQ ACK/NACK signal for uplink transmission. That is, the PHICH indicates a channel through which downlink ACK/NACK information for uplink HARQ is transmitted. The PHICH includes one REG and is cell-specifically scrambled. The ACK/NACK signal is indicated by 1 bit and is modulated by Binary Phase Shift Keying (BPSK). The modulated ACK/NACK signal is spread by a Spreading Factor (SF)=2 or 4. A plurality of PHICHs mapped to the same resource constitutes a PHICH group. The number of PHICHs multiplexed to the PHICH group is determined depending on the number of SFs. The PHICH (group) is repeated three times to obtain diversity gain in a frequency domain and/or a time domain.

The PDCCH, physical downlink control channel, is allocated to the first n OFDM symbols of a subframe. In this case, n is an integer greater than 1 and is indicated by the PCFICH. The PDCCH is comprised of one or more Control Channel Elements (CCEs). The PDCCH informs each UE or UE group of information associated with resource allocation of a Paging Channel (PCH) and a Downlink-Shared Channel (DL-SCH), uplink scheduling grant, Hybrid Automatic Repeat Request (HARQ) information, etc. Therefore, an eNB and a UE transmit and receive data other than specific control information or specific service data through the PDSCH.

Information indicating to which UE or UEs PDSCH data is to be transmitted, information indicating how UEs are to receive PDSCH data, and information indicating how UEs are to perform decoding are contained in the PDCCH. For example, it is assumed that a specific PDCCH is CRC-masked with a Radio Network Temporary Identity (RNTI) “A” and information about data, that is transmitted using radio resources “B” (e.g., frequency location) and transport format information “C” (e.g., transmission block size, modulation scheme, coding information, etc.), is transmitted through a specific subframe. In this case, a UE located in a cell monitors the PDCCH using its own RNTI information. If one or more UEs having the RNTI ‘A’ are present, the UEs receive the PDCCH and receive the PDSCH indicated by ‘B’ and ‘C’ through the received PDCCH information.

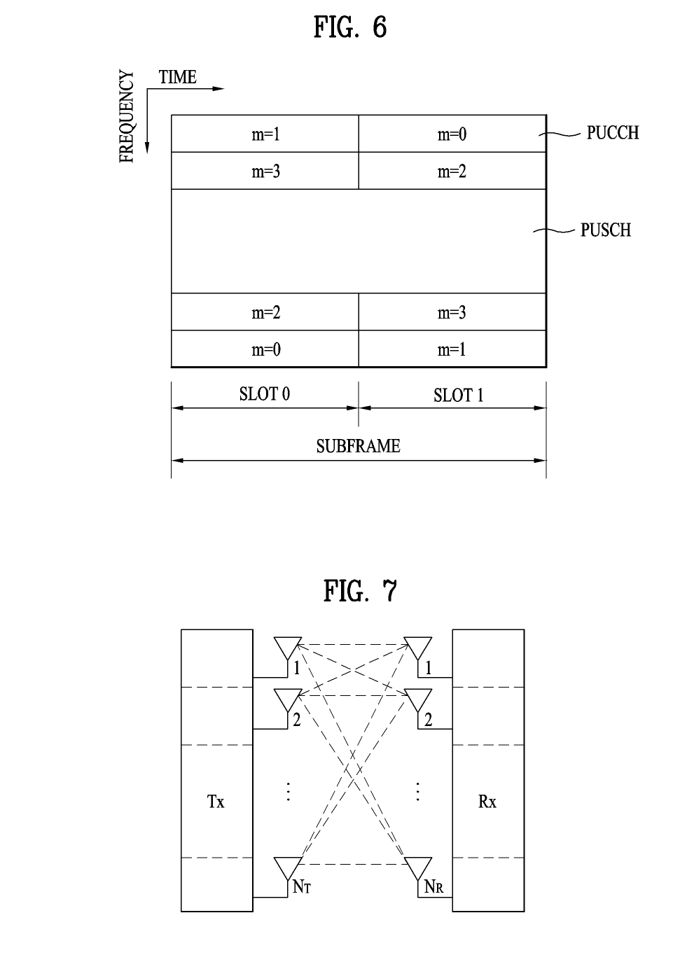

FIG. 6 illustrates the structure of an uplink subframe used in the LTE system.

Referring to FIG. 6, an uplink subframe is divided into a region to which a PUCCH is allocated to transmit control information and a region to which a PUSCH is allocated to transmit user data. The PUSCH is allocated to the middle of the subframe, whereas the PUCCH is allocated to both ends of a data region in the frequency domain. The control information transmitted on the PUCCH includes an ACK/NACK, a CQI representing a downlink channel state, an RI for Multiple Input and Multiple Output (MIMO), a Scheduling Request (SR) indicating a request for allocation of uplink resources, etc. A PUCCH of a UE occupies one RB in a different frequency in each slot of a subframe. That is, two RBs allocated to the PUCCH frequency-hop over the slot boundary. Particularly, FIG. 6 illustrates an example in which PUCCHs for m=0, m=1, m=2, and m=3 are allocated to a subframe.

Hereinafter, a MIMO system will be described. MIMO refers to a method of using multiple transmission antennas and multiple reception antennas to improve data transmission/reception efficiency. Namely, a plurality of antennas is used at a transmitting end or a receiving end of a wireless communication system so that capacity can be increased and performance can be improved. MIMO may also be referred to as ‘multi-antenna’ in this disclosure.

MIMO technology does not depend on a single antenna path in order to receive a whole message. Instead, MIMO technology collects data fragments received via several antennas, merges the data fragments, and forms complete data. The use of MIMO technology can increase system coverage while improving data transfer rate within a cell area of a specific size or guaranteeing a specific data transfer rate. MIMO technology can be widely used in mobile communication terminals and relay nodes. MIMO technology can overcome the limitations of the restricted amount of transmission data of single antenna based mobile communication systems.

The configuration of a general MIMO communication system is shown in FIG. 7. A transmitting end is equipped with N_{T} transmission (Tx) antennas and a receiving end is equipped with N_{R} reception (Rx) antennas. If a plurality of antennas is used both at the transmitting end and at the receiving end, theoretical channel transmission capacity increases unlike the case where only either the transmitting end or the receiving end uses a plurality of antennas. Increase in channel transmission capacity is proportional to the number of antennas, thereby improving transfer rate and frequency efficiency. If a maximum transfer rate using a signal antenna is Rₒ, a transfer rate using multiple antennas can be theoretically increased by the product of the maximum transfer rate Rₒ by a rate increment Rᵢ. The rate increment Rᵢ is represented by the following equation 1 where Rᵢ is the smaller of N_{T} and N_{R}.

Rᵢ=min(N_{T},N_{R}) [Equation 1]

For example, in a MIMO communication system using four Tx antennas and four Rx antennas, it is possible to theoretically acquire a transfer rate four times that of a single antenna system. After theoretical increase in the capacity of the MIMO system was first demonstrated in the mid-1990s, various techniques for substantially improving data transfer rate have been under development. Several of these techniques have already been incorporated into a variety of wireless communication standards including, for example, 3rd generation mobile communication and next-generation wireless local area networks.

Active research up to now related to MIMO technology has focused upon a number of different aspects, including research into information theory related to MIMO communication capacity calculation in various channel environments and in multiple access environments, research into wireless channel measurement and model derivation of MIMO systems, and research into space-time signal processing technologies for improving transmission reliability and transfer rate.

To describe a communication method in a MIMO system in detail, a mathematical model thereof is given below. As shown in FIG. 7, it is assumed that N_{T} Tx antennas and N_{R} Rx antennas are present. In the case of a transmission signal, a maximum number of transmittable pieces of information is N_{T} under the condition that N_{T} Tx antennas are used, so that transmission information can be represented by a vector represented by the following equation 2:

S=└s₁,s₂, . . . s_{N}_{_{T}}┘^{T} [Equation 2]

Meanwhile, individual transmission information pieces s₁, s₂, . . . , s_{N}_{_{T}} may have different transmission powers. In this case, if the individual transmission powers are denoted by P₁, P₂, . . . , P_{N}_{_{T}}, transmission information having adjusted transmission powers can be represented by a vector shown in the following equation 3:

ŝ=[ŝ₁,ŝ₂, . . . ,ŝ_{N}_{_{T}}]^{T}=[P₁s₁,P₂s₂, . . . ,P_{N}_{_{T}}s_{N}_{_{T}}]^{T} [Equation 3]

The transmission power-controlled transmission information vector ŝ may be expressed as follows, using a diagonal matrix P of a transmission power:

$$\hat{s} = [ \begin{matrix}{P}_{1} & & & 0 \\ & {P}_{2} & & \\ & & ⋱ & \\ 0 & & & {P}_{{N}_{T}}\end{matrix} ] [ \begin{matrix}{S}_{1} \\ {S}_{2} \\ ⋮ \\ {S}_{{N}_{T}}\end{matrix} ] = Ps * 78 \qquad [ Equation 4 ]$$

NT transmission signals x₁, x₂, . . . , x_{N}_{_{T}} to be actually transmitted may be configured by multiplying the transmission power-controlled information vector ŝ by a weight matrix W. In this case, the weight matrix is adapted to properly distribute transmission information to individual antennas according to transmission channel situations. The transmission signals x₁, x₂, . . . , x_{N}_{_{T}} can be represented by the following Equation 5 using a vector X. In Equation 5, Wᵢⱼ is a weight between the i-th Tx antenna and the j-th information and W is a weight matrix, which may also be referred to as a precoding matrix.

$$X = [ \begin{matrix}{x}_{1} \\ {x}_{2} \\ ⋮ \\ {x}_{i} \\ ⋮ \\ {x}_{{N}_{T}}\end{matrix} ] = [ \begin{matrix}{w}_{11} & {w}_{12} & … & {w}_{1 {N}_{T}} \\ {w}_{21} & {w}_{22} & … & {w}_{2 {N}_{T}} \\ ⋮ & & ⋱ & \\ {w}_{i 1} & {w}_{i 2} & … & {w}_{i {N}_{T}} \\ ⋮ & & ⋱ & \\ {w}_{{N}_{T} 1} & {w}_{{N}_{T} 2} & … & {w}_{{N}_{T} {N}_{T}}\end{matrix} ] [ \begin{matrix}{\hat{S}}_{1} \\ {\hat{S}}_{2} \\ ⋮ \\ {\hat{S}}_{j} \\ ⋮ \\ {\hat{S}}_{{N}_{T}}\end{matrix} ] = W \hat{s} = WPs \qquad [ Equation 5 ]$$

Generally, the physical meaning of a rank of a channel matrix may be a maximum number of different pieces of information that can be transmitted in a given channel. Accordingly, since the rank of the channel matrix is defined as the smaller of the number of rows or columns, which are independent of each other, the rank of the matrix is not greater than the number of rows or columns. A rank of a channel matrix H, rank(H), is restricted as follows.

rank(H)≦min(N_{T},N_{R}) [Equation 6]

Each unit of different information transmitted using MIMO technology is defined as a ‘transmission stream’ or simply ‘stream’. The ‘stream’ may be referred to as a ‘layer’. The number of transmission streams is not greater than a rank of a channel which is a maximum number of different pieces of transmittable information. Accordingly, the channel matrix H may be indicted by the following Equation 7:

# of streams≦rank(H)≦min(N_{T},N_{R}) [Equation 7]

where ‘# of streams’ denotes the number of streams. It should be noted that one stream may be transmitted through one or more antennas.

There may be various methods of allowing one or more streams to correspond to multiple antennas. These methods may be described as follows according to types of MIMO technology. The case where one stream is transmitted via multiple antennas may be called spatial diversity, and the case where multiple streams are transmitted via multiple antennas may be called spatial multiplexing. It is also possible to configure a hybrid of spatial diversity and spatial multiplexing.

Now, a description of a Channel status information (CSI) report is given. In the current LTE standard, a MIMO transmission scheme is categorized into open-loop MIMO operated without CSI and closed-loop MIMO operated based on CSI. Especially, according to the closed-loop MIMO system, each of the eNB and the UE may be able to perform beamforming based on CSI to obtain a multiplexing gain of MIMO antennas. To obtain CSI from the UE, the eNB allocates a PUCCH or a PUSCH to command the UE to feedback CSI for a downlink signal.

CSI is divided into three types of information: a Rank Indicator (RI), a Precoding Matrix Index (PMI), and a Channel Quality Indicator (CQI). First, RI is information on a channel rank as described above and indicates the number of streams that can be received via the same time-frequency resource. Since RI is determined by long-term fading of a channel, it may be generally fed back at a cycle longer than that of PMI or CQI.

Second, PMI is a value reflecting a spatial characteristic of a channel and indicates a precoding matrix index of the eNB preferred by the UE based on a metric of Signal-to-Interference plus Noise Ratio (SINR). Lastly, CQI is information indicating the strength of a channel and indicates a reception SINR obtainable when the eNB uses PMI.

In an evolved communication system such as an LTE-A system, multi-user diversity using Multi-User MIMO (MU-MIMO) is additionally obtained. Since interference between UEs multiplexed in an antenna domain exists in the MU-MIMO scheme, CSI accuracy may greatly affect not only interference of a UE that has reported CSI but also interference of other multiplexed UEs. Hence, in order to correctly perform MU-MIMO operation, it is necessary to report CSI having accuracy higher than that of a Single User-MIMO (SU-MIMO) scheme.

Accordingly, LTE-A standard has determined that a final PMI should be separately designed into W1, which a long-term and/or wideband PMI, and W2, which is a short-term and/or subband PMI.

An example of a hierarchical codebook transform scheme configuring one final PMI from among W1 and W2 may use a long-term covariance matrix of a channel as indicated in Equation 8:

W=norm(W1W2) [Equation 8]

In Equation 8, W2 of a short-term PMI indicates a codeword of a codebook configured to reflect short-term channel information, W denotes a codeword of a final codebook, and norm(A) indicates a matrix in which a norm of each column of a matrix A is normalized to 1.

The detailed configurations of W1 and W2 are shown in Equation 9:

$$W 1 ( i ) = [ \begin{matrix}{X}_{i} & 0 \\ 0 & {X}_{i}\end{matrix} ] , \qquad [ Equation 9 ]$$

where Xᵢ is Nt/2 by M matrix.

$$W 2 ( j ) = \overbrace{[ \begin{matrix}{e}_{M}^{k} & {e}_{M}^{l} & {e}_{M}^{m} \\ {α}_{j} {e}_{M}^{k} & {β}_{j} {e}_{M}^{l …} & {γ}_{j} {e}_{M}^{m}\end{matrix} ]}^{r columns}$$

(if rank=r), where 1≦k, l, m≦M and k, l, m are integer.

where Nt is the number of Tx antennas, M is the number of columns of a matrix Xi, indicating that the matrix Xi includes a total of M candidate column vectors. eMk, eMl, and eMm denote k-th, l-th, and m-th column vectors of the matrix Xi in which only k-th, l-th, and m-th elements among M elements are 0 and the other elements are 0, respectively. αⱼ, βⱼ, and γⱼ are complex values each having a unit norm and indicate that, when the k-th, l-th, and m-th column vectors of the matrix Xi are selected, phase rotation is applied to the column vectors. At this time, i is an integer greater than 0, denoting a PMI index indicating W1 and j is an integer greater than 0, denoting a PMI index indicating W2.

In Equation 9, the codebook configurations are designed to reflect channel correlation properties generated when cross polarized antennas are used and when a space between antennas is dense, for example, when a distance between adjacent antennas is less than a half of signal wavelength. The cross polarized antennas may be categorized into a horizontal antenna group and a vertical antenna group. Each antenna group has the characteristic of a Uniform Linear Array (ULA) antenna and the two groups are co-located.

Accordingly, a correlation between antennas of each group has characteristics of the same linear phase increment and a correlation between antenna groups has characteristics of phase rotation. Consequently, since a codebook is a value obtained by quantizing a channel, it is necessary to design a codebook such that characteristics of a channel are reflected. For convenience of description, a rank-1 codeword generated by the aforementioned configurations is shown as follows:

$$W 1 ( i ) * W 2 ( j ) = [ \begin{matrix}{X}_{i} ( k ) \\ {α}_{j} {X}_{i} ( k )\end{matrix} ] \qquad [ Equation 10 ]$$

In Equation 10, a codeword is expressed as a vector of N_{T}×1 (where NT is the number of Tx antennas) and is structured with an upper vector Xᵢ(k) and a lower vector αⱼXᵢ(k) which show correlation characteristics of a horizontal antenna group and a vertical antenna group, respectively. Xᵢ(k) is preferably expressed as a vector having the characteristics of linear phase increment by reflecting the characteristics of a correlation between antennas of each antenna group and may be a DFT matrix as a representative example.

As described above, CSI in the LTE system includes, but is not limited to, CQI, PMI, and RI. According to transmission mode of each UE, all or some of the CQI, PMI, and RI is transmitted. Periodic transmission of CSI is referred to as periodic reporting and transmission of CSI at the request of an eNB is referred to as aperiodic reporting.

In aperiodic reporting, a request bit included in uplink scheduling information transmitted by the eNB is transmitted to the UE. Then, the UE transmits CSI considering transmission mode thereof to the eNB through an uplink data channel (PUSCH).

In periodic reporting, a period of CSI and an offset at the period are signaled in the unit of subframes by a semi-static scheme through a higher-layer signal per UE. The UE transmits CSI considering transmission mode to the eNB through an uplink control channel (PUCCH). If there is uplink data in a subframe in which CSI is transmitted, the CSI is transmitted through an uplink data channel (PUSCH) together with the uplink data.

The eNB transmits transmission timing information suitable for each UE to the UE in consideration of a channel state of each UE and a UE distributed situation in a cell. The transmission timing information includes a period and an offset necessary for transmitting CSI and may be transmitted to each UE through an RRC message.

Hereinafter, Cooperative Multipoint (CoMP) transmission/reception will be described.

In a system after LTE-A, a scheme for raising system performance by enabling cooperation between a plurality of cells is attempted. Such a scheme is called CoMP transmission/reception. CoMP refers to a scheme in which two or more eNBs, access points, or cells cooperatively communicate with a UE for smooth communication between a specific UE and an eNB, an access point, or a cell. In the present invention, eNB, access point, and cell may be used interchangeably.

In general, in a multi-cell environment in which a frequency reuse factor is 1, the performance of the UE located at a cell edge and average sector throughput may be reduced due to Inter-Cell Interference (ICI). In order to reduce ICI, a legacy LTE system uses a method of enabling the UE located at a cell edge to have appropriate throughput and performance using a simple passive scheme such as Fractional Frequency Reuse (FFR) through UE-specific power control in an environment restricted by interference. However, it is desirable that ICI be reduced or the UE reuse ICI as a desired signal, rather than decreasing the use of frequency resources per cell. In order to accomplish the above purpose, a CoMP transmission scheme may be employed.

FIG. 8 illustrates an example of performing CoMP. Referring to FIG. 8, a radio communication system includes a plurality of eNBs eNB1, eNB2, and eNB3 that perform CoMP and a UE. The plural eNBs eNB1, eNB2, and eNB3 for performing CoMP may efficiently transmit data to the UE through cooperation.

A CoMP transmission scheme may be divided into CoMP-Joint Processing (CoMP-JP) which is a cooperative MIMO type of JP through data sharing and CoMP-Coordinated Scheduling/Coordinated Beamforming (CoMP-CS/CB).

In the case a CoMP-JP scheme in downlink, a UE may simultaneously receive data from a plurality of eNB implementing the CoMP transmission scheme and may improve reception performance by combining signals received from the respective eNBs (Joint Transmission (JT)). In addition, a method in which one of a plurality of eNBs performing the CoMP transmission scheme transmits data to the UE at a specific time point may be considered (Dynamic Point Selection (DPS). In a CoMP-CS/CB scheme in downlink, the UE may instantaneously receive data through one eNB, i.e. a serving eNB by beamforming.

If the CoMP-JP scheme is applied in uplink, a plurality of eNBs may simultaneously receive a PUSCH signal from the UE (Joint Reception (JR)). In the case of CoMP-CS/CB in uplink, only one eNB may receive a PUSCH signal. Cooperative cells (or eNBs) may determine to use the CoMP-CS/CB scheme.

A UE using the CoMP transmission scheme, i.e. a CoMP UE, may feed back channel information feedback (hereinafter, CSI feedback) to a plurality of eNBs performing the CoMP transmission scheme. A network scheduler may select a proper CoMP transmission scheme capable of raising a transmission rate among the CoMP-JP, CoMP-CS/CB, and DPS schemes based on CSI feedback. To this end, a periodic feedback transmission scheme using a PUCCH may be used as a method in which the UE configures CSI feedback in a plurality of eNBs performing the CoMP transmission scheme. In this case, feedback configurations for the eNBs may be independent of one another. Accordingly, in the disclosure according to an embodiment of the present invention, an operation of feeding back CSI with such an independent feedback configuration is referred to as a CSI process. One or more CSI processes may be performed in one serving cell.

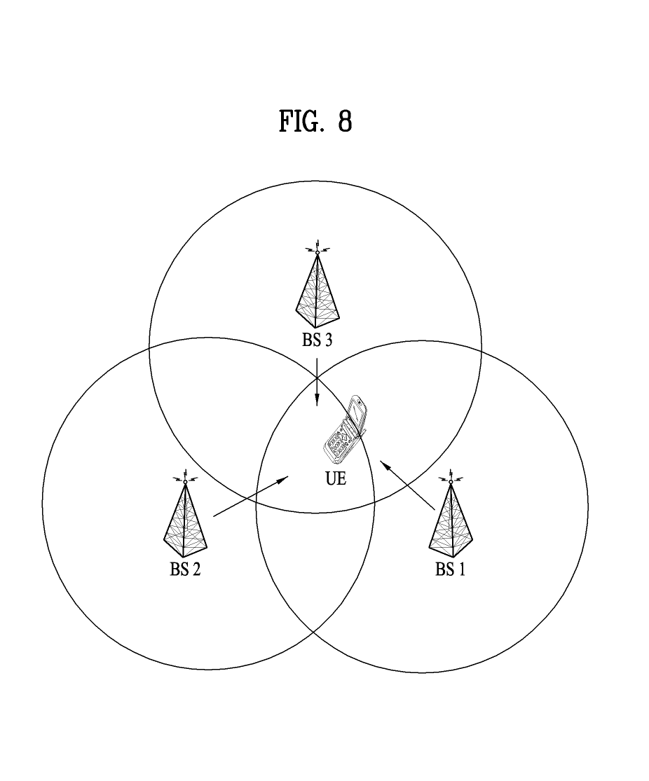

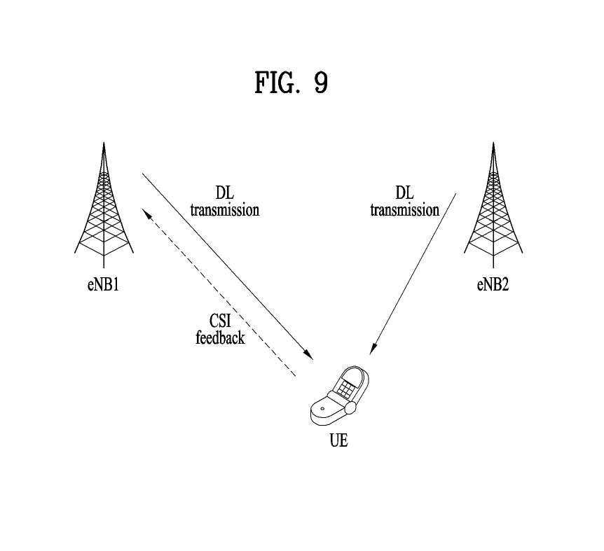

FIG. 9 illustrates a downlink CoMP operation.

In FIG. 9, a UE is positioned between an eNB1 and an eNB2 and the two eNBs, i.e. eNB1 and eNB2, perform a proper CoMP operation such as JT, DCS, or CS/CB to solve a problem of interference to the UE. To aid in the CoMP operation of the eNBs, the UE performs proper CSI feedback. Information transmitted through CSI feedback includes PMI and CQI of each eNB and may additionally include channel information between the two eNBs (e.g. phase offset information between two eNB channels) for JT.

In FIG. 9, although the UE transmits a CSI feedback signal to the eNB1 which is a serving cell thereof, the UE may transmit the CSI feedback signal to the eNB2 or the two eNBs, according to situation. In addition, in FIG. 16, while the eNBs are described as a basic unit participating in CoMP, the present invention may be applied to CoMP between Transmission Points (TPs) controlled by a single eNB.

That is, for CoMP scheduling in a network, the UE should feed back not only downlink CSI of a serving eNB/TP but also downlink CSI of a neighboring eNB/TP. To this end, the UE feeds back a plurality of CSI processes reflecting various interference environments of eNBs/TPs for data transmission.

Accordingly, an Interference Measurement Resource (IMR) is used to measure interference during CoMP CSI calculation in an LTE system. A plurality of IMRs may be configured for one UE and each of the plural IMRs may be independently configured. That is, the period, offset, and resource configuration of the IMR are independently determined and may be signaled by an eNB to a UE using higher layer signaling (RRC etc.).

In addition, a CSI-RS is used to measure a channel desired for CoMP CSI calculation in the LTE system. A plurality of CSI-RSs may be configured for one UE and each of the CSI-RSs in independently configured. Namely, each CSI-RS includes an independently configured period, offset, resource configuration, power control, and the number of antenna ports and information related to the CSI-RS is signaled to the UE from the eNB through higher layer signaling (RRC etc.).

Among a plurality of CSI-RSs and a plurality of IMRs configured for a UE, one CSI process may be defined in association with one CSI-RS resource for signal measurement and one IMR for interference measurement. The UE feeds back CSI having different periods and subframe offsets, derived from different CSI processes, to a network (e.g. eNB).

That is, each CSI process has an independent CSI feedback configuration. The eNB may signal the CSI-RS resource, IMR association information, and CSI feedback configuration to the UE through higher layer signaling of RRC etc. on a CSI process basis. For example, it is assumed that three CSI processes as shown in Table 1 are configured for the UE.

TABLE 1

| | Signal Measurement | |
|---|---|---|
| CSI Process | Resource (SMR) | IMR |
| CSI process 0 | CSI-RS 0 | IMR 0 |
| CSI process 1 | CSI-RS 1 | IMR 1 |
| CSI process 2 | CSI-RS 0 | IMR 2 |

In Table 1, CSI-RS 0 and CSI-RS 1 indicate a CSI-RS received from an eNB 1 which is a serving eNB of the UE and a CSI-RS received from an eNB 2 which is a neighboring eNB participating in cooperation. It is assumed that IMRs configured for the CSI processes of Table 1 are configured as shown in Table 2.

TABLE 2

| IMR | eNB 1 | eNB 2 |
|---|---|---|
| IMR 0 | Muting | Data transmission |
| IMR 1 | Data transmission | Muting |
| IMR 2 | Muting | Muting |

In IMR 0, the eNB 1 performs muting, the eNB 2 performs data transmission, and the UE is configured to measure interference of eNBs except for the eNB 1 from IMR 0. Similarly, in IMR 1, the eNB 2 performs muting, the eNB 1 performs data transmission, and the UE is configured to measure interference of eNBs except for the eNB 2 from IMR 1. In addition, in IMR 2, both the eNB 1 and eNB2 perform muting and the UE is configured to measure interference of eNBs except for the eNB1 and eNB 2 from IMR 2.

Accordingly, as shown in Table 1 and Table 2, CSI of CSI process 0 indicates optimal RI, PMI, and CQI when data is received from the eNB 1. CSI of CSI process 1 indicates optimal RI, PMI, and CQI when data is received from the eNB 2. CSI of CSI process 2 indicates optimal RI, PMI, and CQI, when data is received from the eNB 1 and there is no interference from the eNB 2.

Research has currently been actively conducted on introduction of an active antenna system (AAS) in next generation mobile communication. The AAS is a technology that can be more efficiently applied to perform beamforming or reduce interference by changing an antenna pattern according to circumstance.

When the AAS is configured as a two-dimensional AAS (2D-AAS), it is possible to more actively change a transmission beam according to a position of a receiving end by more efficiently and three-dimensionally adjusting a main lobe of an antenna in terms of antenna pattern.

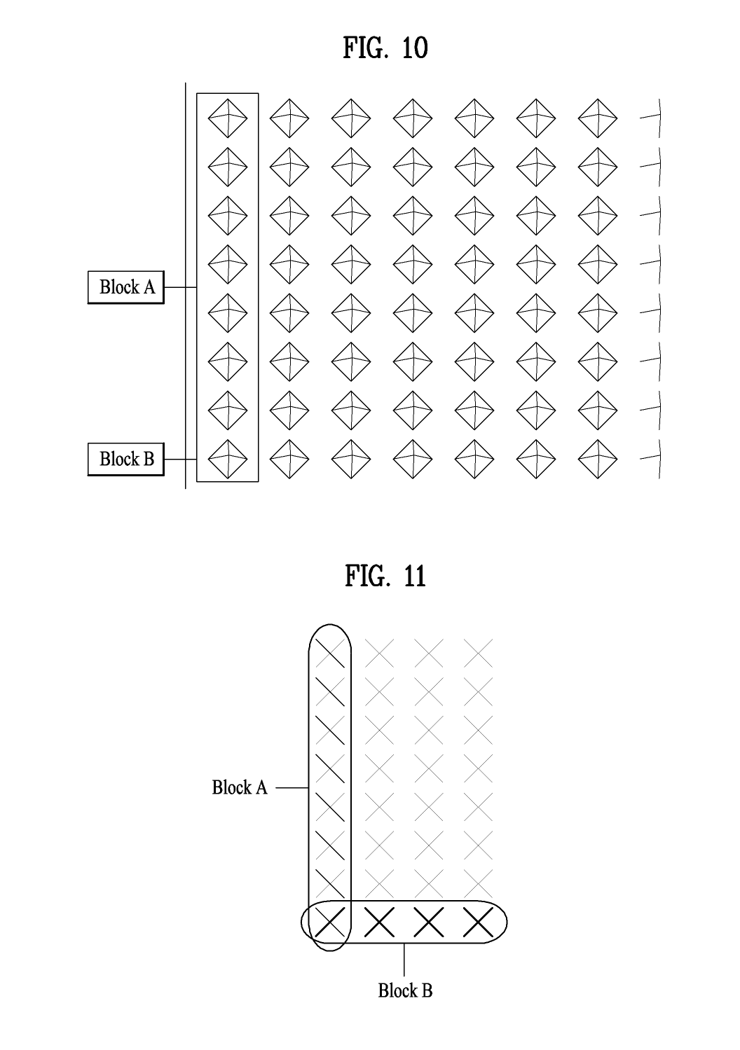

FIG. 10 illustrates an example of implementation of the 2D-AAS. In particular, FIG. 10 presumes a co-polarized antenna array in which each antenna element has the same polarization.

Referring to FIG. 10, the 2D-AAS is expected to be constructed as a system having a plurality of antennas by installing antennas in a vertical direction and a horizontal direction.

Meanwhile, it is possible to consider a cross-polarized antenna array (X-pol AA) instead of the co-polarized antenna array illustrated in FIG. 10.

FIG. 11 is an example of implementation of the cross-polarized antenna array having 64 antenna elements. Similarly to FIG. 10, it can be understood that Group A and Group B are configured for respective antenna arrays in the vertical direction and the horizontal direction.

If the 2D-AAS is introduced, a transmitting end needs to transmit a specific RS (e.g., CSI-RS) to a receiving end in order to provide the receiving end with information about channels from the transmitting end to the receiving end. In the current LTE system, the CSI-RS is designed as a 1-port, 2-port, 4-port, or 8-port CSI-RS. This is generalized to use of n REs for each n-port CSI-RS (n>1) in one RB.

In the 2D-AAS case illustrated in FIG. 10, there are eight antennas in a vertical direction and eight antennas in a horizontal direction. Thus, a total of 64 antennas are arranged. Then, conventionally 64 REs should be used to carry CSI-RSs in one RB. As a result, CSI-RS overhead based on the number of antennas may be problematic.

To avert the problem, it has recently been discussed that only a part of CSI-RS ports are configured for a UE and the UE feeds back CSI using the partial CSI-RS ports. One of such schemes, Beamformed CSI-RS (BF CSI-RS)-based CSI feedback will be described.

An eNB configures BF CSI-RS ports to all of which the same vertical beam is applied, for a UE. The vertical beam is controlled to a specific vertical tilting angle as a target angle, and BF CSI-RSs may be generated simply by multiplying a transmission signal by a Discrete Fourier Transform (DFT) vector.

For example, one BF CSI-RS port may be generated through block A illustrated in FIG. 11. Block A is an 8×1 vertical antenna array having the same polarization property, and a vertical beam may be generated at a specific vertical tilting angle by multiplying block A by an 8×1 DFT vector. In this manner, the remaining seven blocks each being an 8×1 vertical antenna array with the same polarization property may be produced in FIG. 11. Seven BF CSI-RS ports may be generated by applying the same DFT vector as used for block A to the remaining seven blocks.

An 8-port BF CSI-RS generated in the above manner is configured for a UE, and the UE generates CSI using the CSI-RS. Because vertical beamforming has already been applied to the CSI-RS, the CSI generated by the UE means an optimal horizontal RI and PMI obtained on the assumption that the specific vertical beam has been used, and a CQI obtained for the case where the specific vertical beam and the optimal horizontal RI and PMI are used.

While one 8-port BF CSI-RS has been configured for a UE in the above example, this may be extended to configuring another 8-port BF CSI-RS to which another vertical beam is applied. For example, 8-port BF CSI-RS #1 to which vertical beam #1 is applied and 8-port BF CSI-RS #2 to which vertical beam #2 is applied are configured for the UE. Although the UE may calculate and report independent CSI for each BF CSI-RS, it is preferred that the UE calculates CSI on the assumption that the eNB transmits data using all BF CSI-RS channels simultaneously. Accordingly, when a PMI and an RI are determined for one BF CSI-RS, the PMI and the RI are preferably determined in consideration of a PMI and an RI calculated for the latest determined remaining BF CSI-RS. Preferably, a CQI is also calculated on the assumption that the eNB transmits data on all BF CSI-RS channels using the reported PMI and RI.

In summary, an N-Tx CSI-RS and an N-Tx PMI should be defined newly for CSI feedback in a massive MIMO environment in which an eNB has many transmission antennas. However, considering RS overhead or feedback overhead, it may be difficult to newly define the N-Tx CSI-RS and N-Tx PMI. In this context, a method for supporting massive MIMO feedback using a legacy M-Tx CSI-RS and M-Tx PMI is under discussion.

In the present invention, support of massive MIMO feedback in a single PUCCH feedback chain-based single CSI process will be described. A feedback chain refers to preliminarily reserved PUCCH resources for CSI reporting with a predetermined period and offset.

A CSI process defined in the current 3GPP TS 36.331 document is given as follows.

TABLE 3
-- ASN1START

| CSI-Process-r11 : : = | | SEQUENCE { | | |
|---|---|---|---|---|
| csi-ProcessId-r11 | | CSI-ProcessId-r11, | | |
| csi-RS-ConfigNZPId-r11 | | CSI-RS-ConfigNZPId-r11, | | |
| csi-IM-ConfigId-r11 | | CSI-IM-ConfigId-r11, | | |
| p-C-AndCBSRList-r11 | | SEQUENCE SIZE (1. .2)) OF P-C-AndCBSR-r11, | | |
| cqi-ReportBothProc-r11 | | CQI-ReportBothProc-r11 | OPTIONAL, | -- Need OR |
| cqi-ReportPeriodicProcId-r11 | | INTEGER (0 . .maxCQI-ProcExt-r11) | OPTIONAL, | -- Need OR |
| cqi-ReportAperiodicProc-r11 | | CQI-ReportAperiodicProc-r11 | OPTIONAL, | -- Need OR |
| . . . , | | | | |
| [[ | alternativeCodebookEnabledFcr4TXProc-r12 ENUMERATED {true} | | OPTIONAL, | -- Need OR |
| | csi-IM-ConfigIdList-r12 | SEQUENCE (SIZE (1. .2)) OF CSI-IM-ConfigId-r12 | | OPTIONAL, |
| -- Cond CSIIMREL12 | | | | |
| | cgi-ReportAperiodicProcSecond-r12 | CQI-ReportAperiodicProc-r11 | OPTIONAL | -- Need OR |

| | |
|---|---|
| ]] | |
| } | |
| P-C-AndCBSR-r11 ::= SEQUENCE { | |
| p-C-r11 | INTEGER (−8. . 15), |
| codebookSubsetRestriction-r11 | BIT STRING |
| } | |
| -- ASN1STOP | |

According to an embodiment of the present invention, one CSI process is configured for a UE, and the UE configures a plurality of BF CSI-RSs by applying different vertical beamforms to the CSI process. As in a legacy CSI process, only one CSI-Interference Measurement resource (CSI-IM) is configured and the same CSI-IM is used for calculation of CSI for each BF CSI-RS. The UE simultaneously feeds back CSI for the plurality of CSI-RSs through one PUCCH feedback chain configured for the CSI process.

For example, CSI process #1 is configured for the UE, and both 8-port BF CSI-RS #1 to which vertical beam #1 is applied and 8-port BF CSI-RS #2 to which vertical beam #2 is applied are configured in CSI process #1. That is, csi-RS-ConfigNZPId-r11 meaning 8-port BF CSI-RS #1 and csi-RS-ConfigNZPId-r11 meaning 8-port BF CSI-RS #2 are configured in the CSI process Information Element (IE) illustrated in [Table 3]. Because one PUCCH feedback chain is defined, cqi-ReportPeriodicProcId-r11 is defined as one value in the CSI process IE illustrated in [Table 3]. Although p-C-AndCBSRList-r11 may be applied commonly to the BF CSI-RSs configured in the CSI process, p-C-AndCBSRList-r11 may be defined for each BF CSI-RS, for more flexible operation.

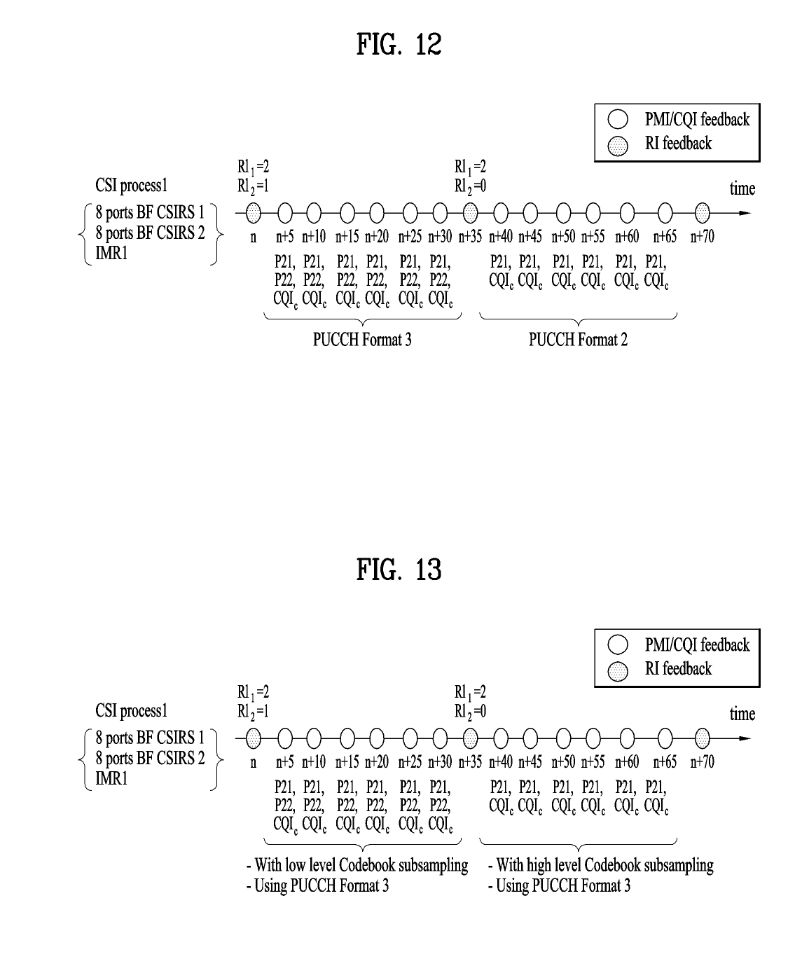

FIG. 12 illustrates an example of CSI feedback through one PUCCH feedback chain according to an embodiment of the present invention. In FIG. 12, a PUCCH CSI feedback is transmitted every 5 ms. Particularly, an RI is reported every 35 ms and a PMI/CQI is reported in the remaining PUCCH CSI feedback subframes.

The UE operation illustrated in FIG. 12 will be described in time order.

RIs are initially reported at time n. Specifically, RI₁ calculated based on CSI-RS #1 and RI₂ calculated based on CSI-RS #2 are reported together at time n. RI₁ and RI₂ may be jointly encoded, thus reducing a payload size. Further, RI₁ may be limited to a value equal to or larger than RI₂.

P21, P22, and CQI_{c} are reported in PUCCH resources at the same time point. Since the payload size of PUCCH format 2 is limited to 11 bits, PUCCH format 2 may be unsuitable for reporting P21, P22, and CQI_{c}. To transmit accurate P21, P22, and CQI_{c} for sufficient performance, there is a need for a new PUCCH format that may transmit larger payload. For example, it is preferable to report P21, P22, and CQI_{c} in PUCCH format 3 having a payload size of 22 bits.

As RI₂ is set to 0 at time N+35, the UE does not report P22. In this case, sufficiently accurate P21 and CQI_{c} may be reported even in the legacy PUCCH format 2. That is, it is preferred that if one of the RIs is set to 0 and a PMI linked to the RI does not need to be transmitted, CSI is transmitted in a PUCCH format having a small payload size, and otherwise, CSI is transmitted in a PUCCH format having a small payload size (a large payload size?). When the size of payload to be fed back is changed, the UE preferably changes a PUCCH format according to the changed payload size.

In another method, a PUCCH format suitable for a maximum payload size may be fixedly used, and if the number of actual CSI types to be transmitted is reduced, CSI to be reported may be fed back accurately.

FIG. 13 illustrates another example of CSI feedback through one PUCCH feedback chain according to an embodiment of the present invention.

In FIG. 13, although P22 is not reported at time n+40 to time n+65, PUCCH format 3 is still used. To effectively use a larger-capacity PUCCH format, the UE may feed back P21 accurately using a full codebook without subsampling or a codebook with high-level subsampling, at time n+40 to time n+65.

High-level subsampling refers to use of a large N value when only N codewords are used in PMI reporting in a codebook with M codewords (N is smaller than M). On the contrary, low-level subsampling refers to use of a small N value. A low-level or high-level codebook subsampling scheme and a condition for applying the low-level or high-level codebook subsampling scheme have already been preset between the eNB and the UE.

For example, the eNB and the UE agree that after one of RI₁ and RI₂ is set to 0, a PMI corresponding to the other RI is reported using specific high-level codebook subsampling.

In FIG. 13, both RI₁ calculated based on CSI-RS 1 at time n and RI₂ calculated based on CSI-RS 2 at time n have effective values being greater than 1. As a result, the UE should report all of CSI corresponding to CSI-RS 1 and CSI corresponding to CSI-RS 2 at time n+5 to time n+30. But, since RI₂ calculated based on CSIRS 2 at time n+35 is 0, the UE may not calculate CSI corresponding to CSIRS 2 at time n+40 to time n+65, but may report CSI corresponding to CSIRS 1. That is, the UE may inform which CSI-RS is selected among multiple CSI-RSs defined in single CSI process via the RI reporting. Since the UE may select one or more CSI-RSs for the CSI reporting via the RI reporting at time n and time n+35, a reporting type at time n+5 to time n+30 and a reporting type at time n+40 to time n+65 are determined based on the RI reporting at time n and time n+35, respectively. For example, the reporting type at time n+5 to time n+30 comprises P21, P22 and CQI_{c}. Further, the reporting type at time n+40 to time n+65 comprises P21 and CQI_{c}.

In another method, a PUCCH format for PMI/CQI transmission may still be maintained, and CSI may be transmitted separately at a plurality of time points in order not to exceed a payload size.

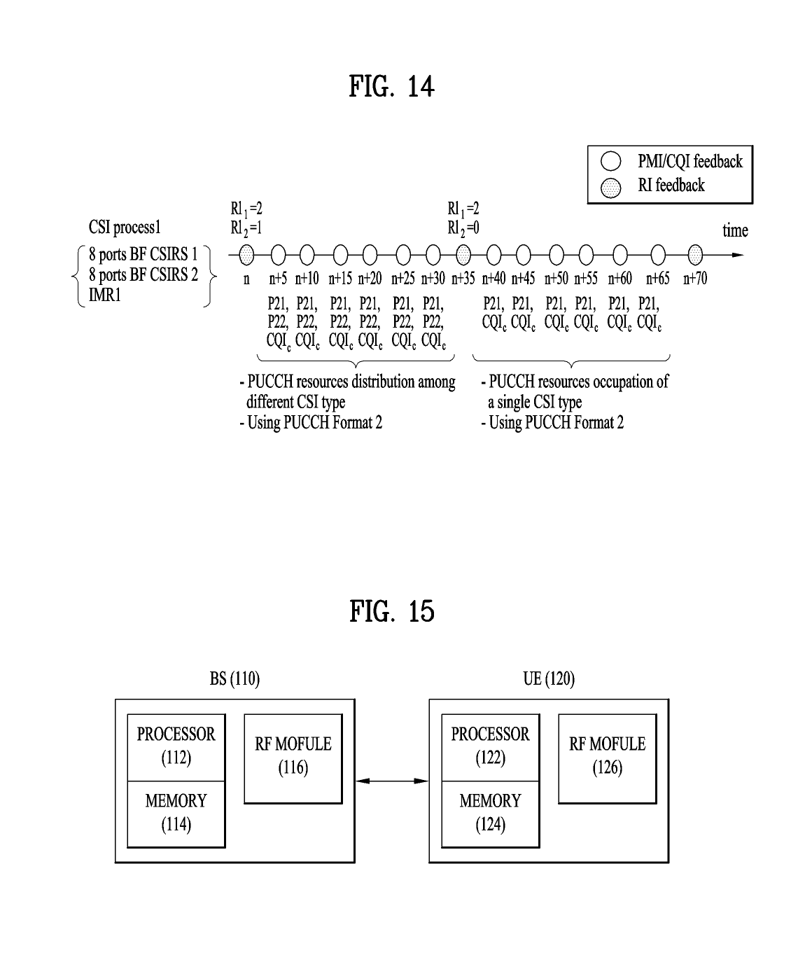

FIG. 14 illustrates another example of CSI feedback through one PUCCH feedback chain according to an embodiment of the present invention.

In FIGS. 14, P21 and P22 are not transmitted together and are transmitted in different PUCCH resources. P21 and P22 are fed back alternately in PUCCH resources at time n+5 to time n+30. The UE may transmit P21 and P22 by dividing PUCCH resources at an arbitrary ratio. In FIG. 14, PUCCH resources are divided at a ratio of 1:1, by way of example. The eNB or the UE may indicate the resource ratio to the UE or the eNB, or a fixed resource ratio may be used.

As RI₂ is set to 0 at time n+35, P22 is not fed back at time n+40 to time n+65. In this case, the PUCCH resource ratio may be changed adaptively, and resource efficiency may be increased by allocating more PUCCH resources to a reported CSI type. That is, all PUCCH resources may be used for P21 at time n+40 to time n+65.

Additionally, CQI_{c} may not be reported at time points when P22 is reported, among time n+5 to time n+30. In this case, more accurate CSI feedback is possible by using a different codebook subsampling level for P22. The eNB or the UE may determine a PMI to be reported together with CQI_{c} and indicate the determined PMI to the UE or the eNB. Or it is defined that CQI_{c} is always reported together with a PMI corresponding to a lowest-index CSI-RS. Or it is defined that CQI_{c} is always reported together with a PMI calculated based on a lowest-index CSI-RS among PMIs corresponding to RIs set to non-zeroes.

FIGS. 12 and 13 illustrate examples of changing a PUCCH format or a subsampling level for time n+40 to time n+65. Obviously, both a PUCCH format and a subsampling level may be changed for time n+40 to time n+65 by applying the two cases in combination.

Adaptive feedback schemes have been proposed in FIGS. 12, 13, and 14, in which as an RI is set to 0, a PMI/CQI payload size is changed and the changed payload size is effectively used. However, changing an RI is a mere example of effectively using the proposed method, and may be extended to any case in which a PMI/CQI payload size is changed.

For example, one of a plurality of CSI-RS resources defined for one CSI process may be selected using a Beam Index (BI) in the current standard, and only CSI for the CSI-RS may be fed back. If one 4-port CSI-RS resource and one 8-port CSI-RS resource are defined for one CSI process, a PMI payload size is changed depending on a CSI-RS resource selected by a BI. Therefore, the present invention may also be extended to a case in which a PMI/CQI payload size is changed according to a BI value.

FIG. 15 is a diagram showing a BS and a UE which are applicable to the present invention.

If a wireless communication system includes a relay, communication in a backhaul link is performed between the BS and the relay and communication in an access link is performed between the relay and the UE. Accordingly, the BS and UE shown in FIG. 15 may be replaced with the relay according to situation.

Referring to FIG. 15, a wireless communication system includes a BS 110 and a UE 120. The BS 110 includes a processor 112, a memory 114, and a Radio Frequency (RF) unit 116. The processor 112 may be configured so as to implement the procedures and/or methods proposed in the present invention. The memory 114 is connected to the processor 112 and stores various pieces of information related to operations of the processor 112. The RF unit 116 is connected to the processor 112 and transmits and/or receives RF signals. The UE 120 includes a processor 122, a memory 124, and an RF unit 126. The processor 122 may be configured so as to implement the procedures and/or methods proposed in the present invention. The memory 124 is connected to the processor 122 and stores various pieces of information related to operations of the processor 122. The RF unit 126 is connected to the processor 122 and transmits and/or receives RF signals. The BS 110 and/or the UE 120 may have a single antenna or multiple antennas.

The embodiments of the present invention described hereinabove are combinations of elements and features of the present invention. The elements or features may be considered selective unless otherwise mentioned. Each element or feature may be practiced without being combined with other elements or features. Further, an embodiment of the present invention may be constructed by combining parts of the elements and/or features. Operation orders described in the embodiments of the present invention may be rearranged. Some constructions of any one embodiment may be included in another embodiment and may be replaced with corresponding constructions of another embodiment. It is obvious that claims that are not explicitly cited in each other in the appended claims may be presented in combination as an embodiment of the present invention or included as a new claim by subsequent amendment after the application is filed.

In this document, the embodiments of the present invention have been described centering on a data transmission and reception relationship between a UE and a BS. In some cases, a specific operation described as performed by the BS may be performed by an upper node of the BS. Namely, it is apparent that, in a network comprised of a plurality of network nodes including a BS, various operations performed for communication with a UE may be performed by the BS, or network nodes other than the BS. The term BS may be replaced with the terms fixed station, Node B, eNode B (eNB), access point, etc.

The embodiments of the present invention may be achieved by various means, for example, hardware, firmware, software, or a combination thereof. In a hardware configuration, the embodiments of the present invention may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, the embodiments of the present invention may be implemented in the form of a module, a procedure, a function, etc. For example, software code may be stored in a memory unit and executed by a processor.

The memory unit is located at the interior or exterior of the processor and may transmit and receive data to and from the processor via various known means.

While the above method and apparatus for transmitting a feedback of single feedback chain-based CSI for 3D MIMO in a wireless communication system have been described in the context of a 3GPP LTE system, they are also applicable to various other wireless communication systems than the 3GPP LTE system.

As is apparent from the foregoing description of the embodiments of the present invention, single feedback chain-based CSI can be reported more effectively for application of 3D MIMO in a wireless communication system.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

What is claimed is:

1. A method for reporting Channel Status Information (CSI) to a Base Station (BS) by a User Equipment (UE) in a wireless communication system, the method comprising:
receiving information about one CSI process including information about a first reference signal and a second reference signal from the BS;
generating at least one of first CSI and second CSI based on the first reference signal and the second reference signal; and
mapping at least one of the first CSI and the second CSI to payload of a predetermined size and reporting the mapped CSI in a subframe indicated by the one CSI process to the BS,
wherein if only one of the first CSI and the second CSI is generated, the size of a precoder indication included in the one CSI increases in correspondence with the payload of the predetermined size, or the predetermined size decreases in correspondence with the one CSI.

2. The method according to claim 1, wherein if both of the first CSI and the second CSI are generated, the first CSI and the second CSI are reported individually in different subframes indicated by the one CSI process.

3. The method according to claim 1, wherein if both of the first CSI and the second CSI are generated, the first CSI and the second CSI are reported simultaneously in a subframe indicated by the one CSI process.

4. The method according to claim 1, further comprising, if only one of the first CSI and the second CSI is generated, reporting a rank set to 0 for the other CSI to the BS.

5. The method according to claim 1, wherein vertical beamforming is applied at different angles to the first reference signal and the second reference signal.

6. A User Equipment (UE) in a wireless communication system, the UE comprising:
a wireless communication module configured to transmit and receive signals to and from a Base Station (BS); and
a processor configured to process the signals,
wherein the processor controls the wireless communication module to receive information about one Channel Status Information (CSI) process including information about a first reference signal and a second reference signal from the BS, and controls the wireless communication module to generate at least one of first CSI and second CSI based on the first reference signal and the second reference signal, map at least one of the first CSI and the second CSI to payload of a predetermined size, and report the mapped CSI in a subframe indicated by the one CSI process to the BS, and
wherein if only one of the first CSI and the second CSI is generated, the processor increases the size of a precoder indication included in the one CSI in correspondence with the payload of the predetermined size, or decreases the predetermined size in correspondence with the one CSI.

7. The UE according to claim 6, wherein if both of the first CSI and the second CSI are generated, the processor controls the wireless communication module to report the first CSI and the second CSI individually in different subframes indicated by the one CSI process.

8. The UE according to claim 6, wherein if both of the first CSI and the second CSI are generated, the processor controls the wireless communication module to report the first CSI and the second CSI simultaneously in a subframe indicated by the one CSI process.

9. The UE according to claim 6, wherein if only one of the first CSI and the second CSI is generated, the processor controls the wireless communication module to report a rank set to 0 for the other CSI to the BS.

10. The UE according to claim 6, wherein vertical beamforming is applied at different angles to the first reference signal and the second reference signal.
